(19) United States
(12) Patent Application Publication
(10) Pub. No.: US 2013/0292439 A1
(43) Pub. Date: Nov. 7, 2013

(54) Themed Slip On Cover For A GPS Unit

(71) Applicant: Michael Wayne Cox, Trinity, NC (US)

(72) Inventor: Michael Wayne Cox, Trinity, NC (US)

(21) Appl. No.: 13/539,499

(22) Filed: Jul. 2, 2012

Related U.S. Application Data
(60) Provisional application No. 61/641,237, filed on May 1, 2012.

(51) Int. Cl. B60R 7/06

(52) U.S. Cl. 224/483

(57) ABSTRACT

Disclosed is a single layer, light weight, themed slip on cover for a GPS “unit” that allows the “end user” the ability to display an expression of individual style, character, belief and/or personal concepts. The slip on cover offers the “end user” the ability to theme and cover an existing GPS “unit”. The single layer, light weight, themed slip on cover fits tightly over the existing GPS “unit”, allowing the “end user” unobstructed access to the interactive features and controls of the GPS “unit”. The single layer, light weight, themed slip on cover offers no claimed protection from shock and or impact damage to a GPS “unit”, and is merely a “novelty” cover intended for purposes of display.

### CROSS-REFERENCE TO RELATED APPLICATION

This application is related to and claims priority to U.S. Provisional Patent Application Ser. No. 61/641,237. Filed May 1,2012, entitled Dress Your GPS, the entirety of which is incorporated herein by reference.

### STATEMENT REGARDING FEDERALLY SPONSORED RESEARCH OR DEVELOPMENT

n/a

### BACK GROUND OF THE INVENTION

The Global Positioning System (GPS) is a satellite navigation system that provides “real time” location information, additional interactive communications and entertainment features. The GPS “unit” is a receiver device that utilizes interactive touch screens, coupled interfaces, push-button switches and other interactive controls. An “end user” is a person who uses a specific product. Due to the personalized nature of these electronic devices, it may be desirable for the “end user” to cover these devices so that they can represent an expression of the “end user” individual style, character, belief and/or personal concepts.

### SUMMARY OF THE INVENTION

The present invention may therefore comprise of a single-layer, light weight, themed cover made from materials such as urethane plastic, epoxy resins, PVC or silicon material that is molded, cast, poured and/or injection molded to produce a light weight themed cover. The cover easily slips over and covers a portion of the front, sides and portion of the rear of an existing GPS “unit”. This single-layer, light weight, themed cover applies to a dash and/or windshield mounted GPS “unit”. The light weight cover allows a uniform shape, tight fit, and provides openings, that allow an “end user” unobstructed access to the interactive features and controls of said GPS “unit”.

### BRIEF DESCRIPTION OF THE DRAWINGS

FIG. 1 is a front plan view of one light weight, themed GPS “unit” cover.

FIG. 2 is a front perspective view of one light weight, themed GPS “unit” cover.

FIG. 3 is a rear plan view of one light weight, themed GPS “unit” cover.

FIG. 4 is a bottom perspective view of one light weight, themed GPS “unit” cover.

FIG. 5 is a rear perspective view of one light weight, themed GPS “unit” cover.

FIG. 6. is a top perspective view of one light weight, themed GPS “unit” cover.

### DETAILED DESCRIPTION OF THE DRAWINGS

FIG. 1 Shows a front plain view of one light weight, themed GPS “unit” cover. The light weight GPS “unit” cover applies to a dash and/or windshield mounted GPS “unit” and covers a large portion of the GPS “unit” with unobstructed access to the interactive features, and said controls of said GPS “unit”. The light weight, GPS “unit” cover can be made from a single layer material such as urethane plastic, casting epoxy resins, PVC or silicon material that is molded, cast, poured and/or injection molded to produce the light weight themed cover. The light weight, themed cover has a varying thickness of 0.0625 up to 0.3125 inches.

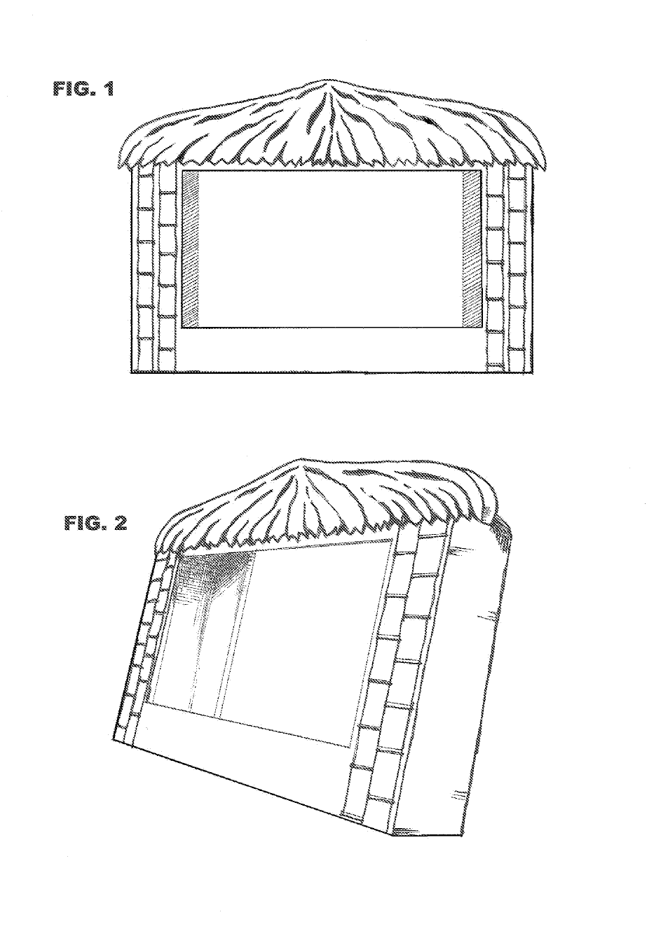

FIG. 2 Shows a front perspective view of one light weight, themed GPS “unit” cover. The light weight GPS “unit” cover applies to a dash and/or windshield mounted GPS “unit” and covers a large portion of the GPS “unit” with unobstructed access to the interactive features, and said controls of said GPS “unit”. The light weight GPS “unit” cover can be made from a single layer material such as urethane plastic, casting epoxy resins, PVC or silicon material that is molded, cast, poured and/or injection molded to produce the light weight, themed cover. The light weight, themed cover has a varying thickness of 0.0625 up to 0.3125 inches.

FIG. 3 Shows a rear plain view of one light weight, themed GPS “unit” cover. The light weight GPS “unit” cover applies to a dash and/or windshield mounted GPS “unit” and covers a large portion of the GPS “unit” with unobstructed access to the interactive features and said controls of said GPS “unit”. The light weight, GPS “unit” cover can be made from a single layer material such as urethane plastic, casting epoxy resins, PVC or silicon material that is molded, cast, poured and/or injection molded to produce the light weight, themed cover. The light weight, themed cover has a varying thickness of 0.0625 up to 0.3125 inches.

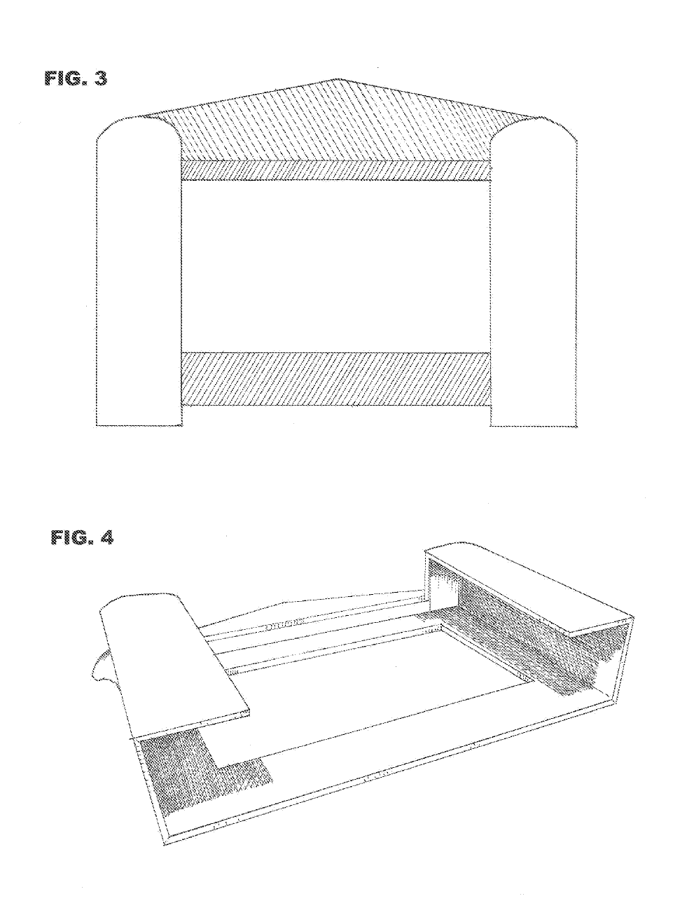

FIG. 4 Shows a bottom perspective view of one light weight, themed GPS “unit” cover. The light weight GPS “unit” cover applies to a dash and/or windshield mounted GPS “unit” and covers a large portion of the GPS “unit” with unobstructed access to the interactive features and said controls of said GPS “unit”. The light weight GPS “unit” cover can be made from a single layer material such as urethane plastic, casting epoxy resins, PVC or silicon material that is molded, cast, poured and/or injection molded to produce the light weight themed cover. The light weight, themed cover has a varying thickness of 0.0625 up to 0.3125 inches.

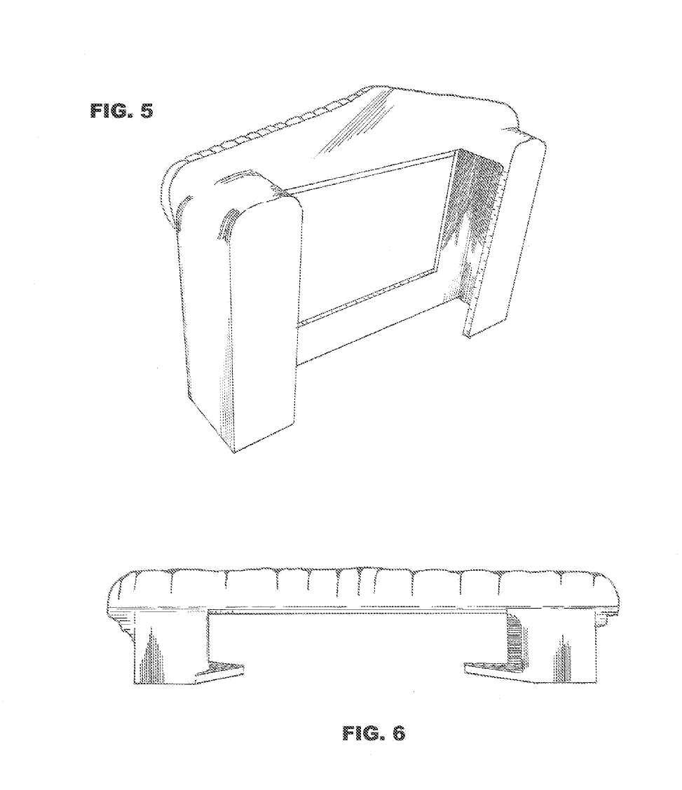

FIG. 5 Shows a rear perspective view of one light weight, themed GPS “unit” cover. The light weight, themed GPS “unit” cover applies to a dash and/or windshield mounted GPS “unit”, and covers a large portion of the GPS “unit” with unobstructed access to the interactive features and said controls of said GPS “unit”. The light weight, GPS “unit” cover can be made from a single layer material such as urethane plastic, casting epoxy resins, PVC or silicon material that is molded, cast, poured and/or injection molded to produce the light weight, themed cover. The light weight, themed cover has a varying thickness of 0.0625 up to 0.3125 inches.

FIG. 6 Shows a top perspective view of one light weight, themed GPS “unit” cover. The light weight GPS “unit” cover applies to a dash and/or windshield mounted GPS “unit” and covers a large portion of the GPS “unit” with unobstructed access to the interactive features and said controls of said GPS “unit”. The light weight, GPS “unit” cover can be made from a single layer material such as urethane plastic, casting epoxy resins, PVC or silicon material that is molded, cast, poured and/or injection molded to produce the light weight, themed cover. The light weight, themed cover has a varying thickness of 0.0625 up to 0.3125 inches.

The provided drawings of one light weight, themed, GPS “unit” cover is being presented to illustrate and describe and not intended to be exhaustive or to limit the invention to a precise form disclosed and other modifications and variations may be possible based on various sizes of available GPS “unit's”. The provided drawing of a light weight, themed GPS “unit” cover is chosen to best describe the principles of this invention and its practical application and allows others skilled in the art to best utilize the invention upon various themes and sizes of GPS “units” with modifications as are intended to a particular available GPS “unit” size.

What is claimed is:

1. A single-layer, light weight, themed slip on GPS “unit” cover comprising of a single-layer, light weight, themed cover that is molded to slip over and cover portions of the front, sides and rear of an existing GPS “unit”. The single-layer, light weight, themed cover applies to a dash and/or windshield mounted GPS “unit”. The light weight cover allows a uniform shape, tight fit and provides openings, allowing an “end user” unobstructed access to the interactive features and controls of said GPS “unit”.
